(19) United States
(12) Patent Application Publication
(10) Pub. No.: US 2002/0181929 A1
(43) Pub. Date: Dec. 5, 2002

(54) Variable optical attenuator

(75) Inventors: Yung-Chieh Hsieh, San Jose, CA (US); Chiayu Ai, Newark, CA (US)

Correspondence Address: John P. Wooldridge, 1334 Ridgestone Court, Livermore, CA, 94550, US

(73) Assignee: Optoplex Corporation

(21) Appl. No.: 09/874,516

(22) Filed: Jun. 4, 2001

(51) Int. Cl. G02B 6/32

(52) U.S. Cl. 385/140; 385/33

(57) ABSTRACT

A variable optical attenuator comprises a collimating element for receiving a light beam originating from an input optical transmission medium, a focusing element opposing the collimating element and operative to substantially focus the light beam upon an output optical transmission medium, and a rotatable optical member (ROM) disposed in between the collimating element and the focusing element and capable of rotating to selectively attenuate the light beam. Attenuation of the beam is accomplished by laterally shifting the beam in the collimating space and producing a cone angle mismatch into an output fiber optic.

### BACKGROUND OF THE INVENTION

1. Field of the Invention

The present invention relates to optical communication, and more specifically, it relates to a low cost variable optical attenuator for use in optical communication.

2. Description of Related Art

Optical attenuators are employed within fiber optic data transmission systems to reduce optical signal power to within targeted ranges. In the field of optical communication, the receiving module can only process light that has a power level that is within the dynamic range of the detection system. If the light level is too high, it saturates the receiving module. The variable optical attenuator (VOA) is usually used to attenuate the light level to within the dynamic range of the receiving module. It is also used to equalize the power levels of various channels.

Several types of VOAs have been used in the past. One such attenuator utilizes a rotatable disk in between a pair of optical fibers. The disk includes a number of partially opaque windows in different angular regions; each designed to attenuate optical energy by a different amount. Rotation of the disk thus produces step-wise changes in the attenuation characteristic. See, for example, U.S. Pat. No. 4,591,231 to Kaiser et al.

Variable attenuation has also been produced by varying the orientation between a pair of optical fibers. One of the fibers can be maintained in a fixed position while the other fiber is mounted on a movable surface that allows its terminal end to be axially or angularly moved relative to the fixed fiber. Differing attenuation values as a function of the moving fiber's position are thereby achieved due to the imperfect transmission between the fibers.

U.S. Pat. No. 4,904,044 to T. Tamulevich discloses a variable optical attenuator employing a flexible film with an optical density gradient that varies along its length. As the film is displaced across an optical coupling region between two fibers, the attenuation characteristic changes continuously rather than in a step-wise manner.

U.S. Pat. No. 6,163,643 titled “Micro-Mechanical Variable Optical Attenuators” is directed towards an electronically variable optical attenuator with focusing optics that enable the use of a micro-mechanical actuation device with minute movement properties. The actuation device controls the depth of penetration of a light-blocking member into the path of a focused light beam to thereby control the attenuation of the light beam.

It is desirable to produce a variable optical attenuator that produces a desired attenuation by appropriately rotating an optically transmissive substrate.

### SUMMARY OF THE INVENTION

It is an object of the present invention to provide embodiments of variable optical attenuators and their methods of fabrication and use.

Other objects will be apparent from the disclosure herein.

An embodiment of the invention is a variable optical attenuator (VOA), comprising a collimating element for receiving a light beam originating from an input optical transmission medium, a focusing element opposing the collimating element and operative to substantially focus the light beam upon an output optical transmission medium, and a rotatable optical member (ROM) disposed in between the collimating element and the focusing element and capable of rotating to selectively attenuate said light beam. The ROM selectively attenuates the light beam as a function of the angular position of the ROM relative to the light beam. Attenuation of the beam is accomplished by laterally shifting the beam in the collimating space and producing a cone angle mismatch into an output fiber optic.

The focusing element substantially focuses the light beam in an output cone angle. In operation, the ROM laterally shifts the light beam in the collimating space and produces a cone angle mismatch between the output cone angle of the focusing element and the acceptance cone angle of the output fiber optic, thus selectively altering the coupling efficiency into the output fiber optic.

### BRIEF DESCRIPTION OF THE DRAWINGS

FIGS. 1A and 1B illustrate the attenuating mechanism of the present invention.

FIGS. 2A shows the coupling efficiency as a function of cone angle mismatch.

FIGS. 2B shows the coupling efficiency in dB.

FIG. 3A shows the coupling efficiency as a function of beam offset.

FIG. 3B shows a magnified portion of FIG. 3A.

FIG. 4 shows the geometry of the beam offset and the incident angle.

FIG. 5 shows the beam offset as a function of incident angle for silicon (n=3.5, solid curve) and glass (n=1.5, dashed curve).

FIGS. 6A and 6B illustrate an alternate embodiment of the invention.

### DETAILED DESCRIPTION OF THE INVENTION

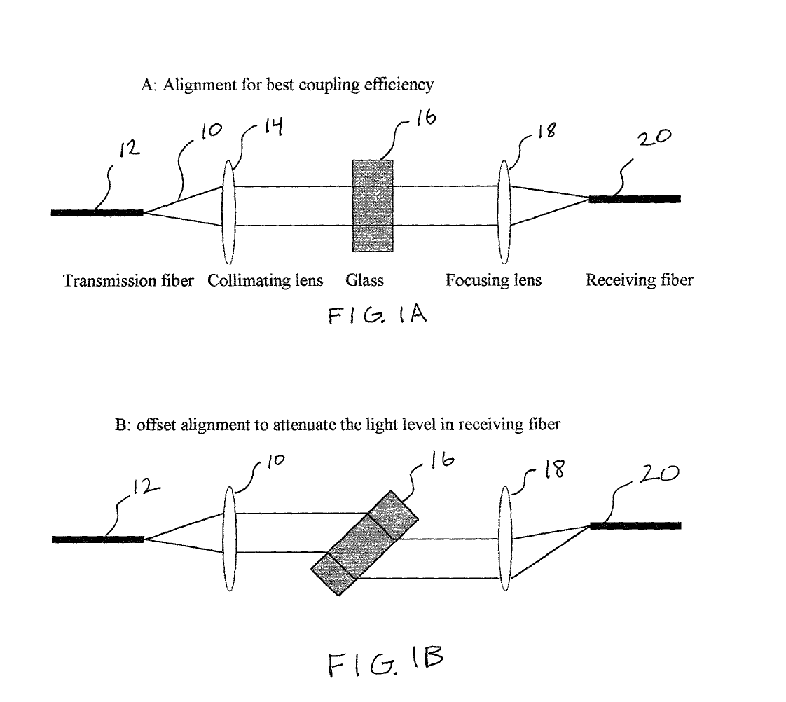

FIGS. 1A and 1B illustrate the attenuating mechanism of the present invention. In FIG. 1A, light 10 from a transmission fiber 12 is collimated by lens 14. The collimated beam passes through an optically transmissive substrate (e.g., a glass or silicon, etc.) 16 and is then focused by focusing lens 18 into receiving fiber 20. Since the substrate 16 normal is parallel to the direction of beam propagation, the beam hits the central part of lens 18 and the coupling efficiency is optimized. In FIG. 1B, the beam has a lateral shift after passing through the tilted substrate 16, resulting in a cone angle mismatch; therefore, the coupling efficiency is reduced.

The mode field diameter (MFD) of a single mode fiber (SMF)-28 fiber is about 10.5 μm at wavelength is 1.55 μm. The beam divergent angle (1/e² radius) is 5.4 degrees. The correlation between cone angle mismatch and the coupling efficiency, η, satisfies the following equation.

$$\begin{matrix}η = exp [ - {( \frac{θ}{{θ}_{o}} )}^{2} ] \\ = exp [ - {( \frac{Δ}{{θ}_{o} f} )}^{2} ] \\ {θ}_{o} = \frac{λ}{π {r}_{o}} ;\end{matrix} \qquad Equation ( 1 )$$

where

λ: Wave length (=1.55 μm);

rₒ: the Gaussian radius (=5.25 μm);

θₒ: the Gaussian divergence angle (=5.4 degrees);

θ: The mismatch in cone angle;

η: Coupling efficiency;

Δ: the beam shift in the collimating space; and

f: the effective focal lengh of tht GRIN lens (=1.953 mm).

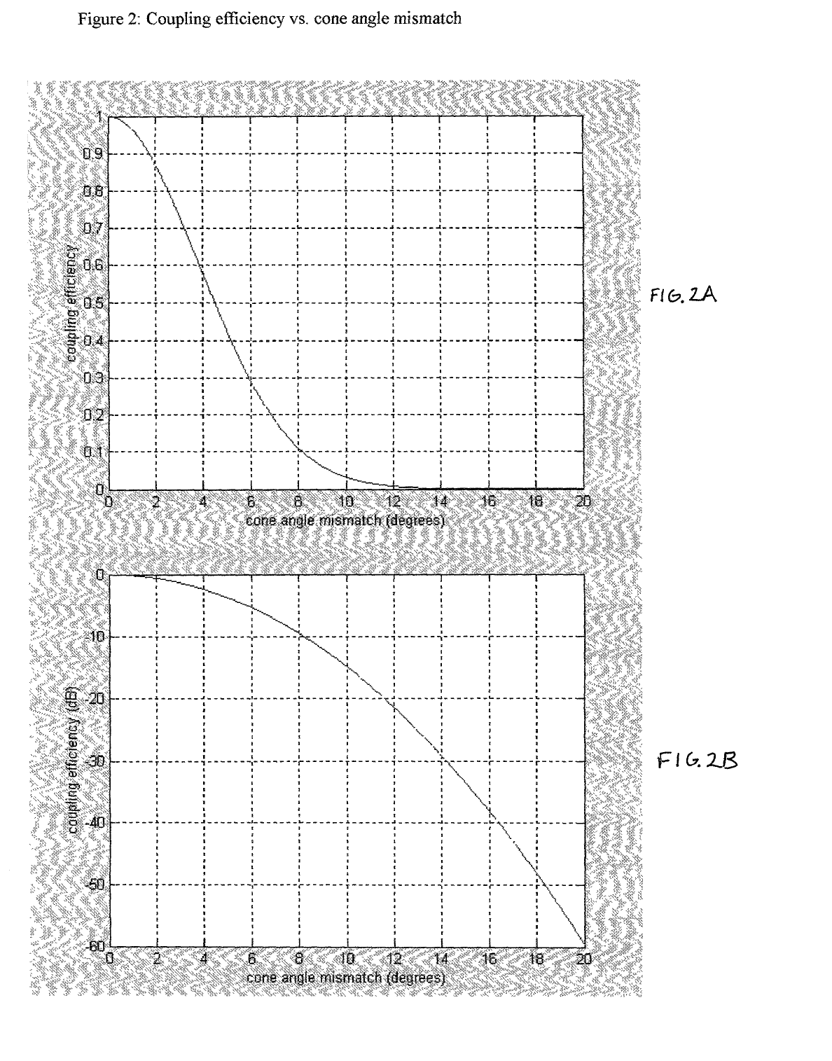

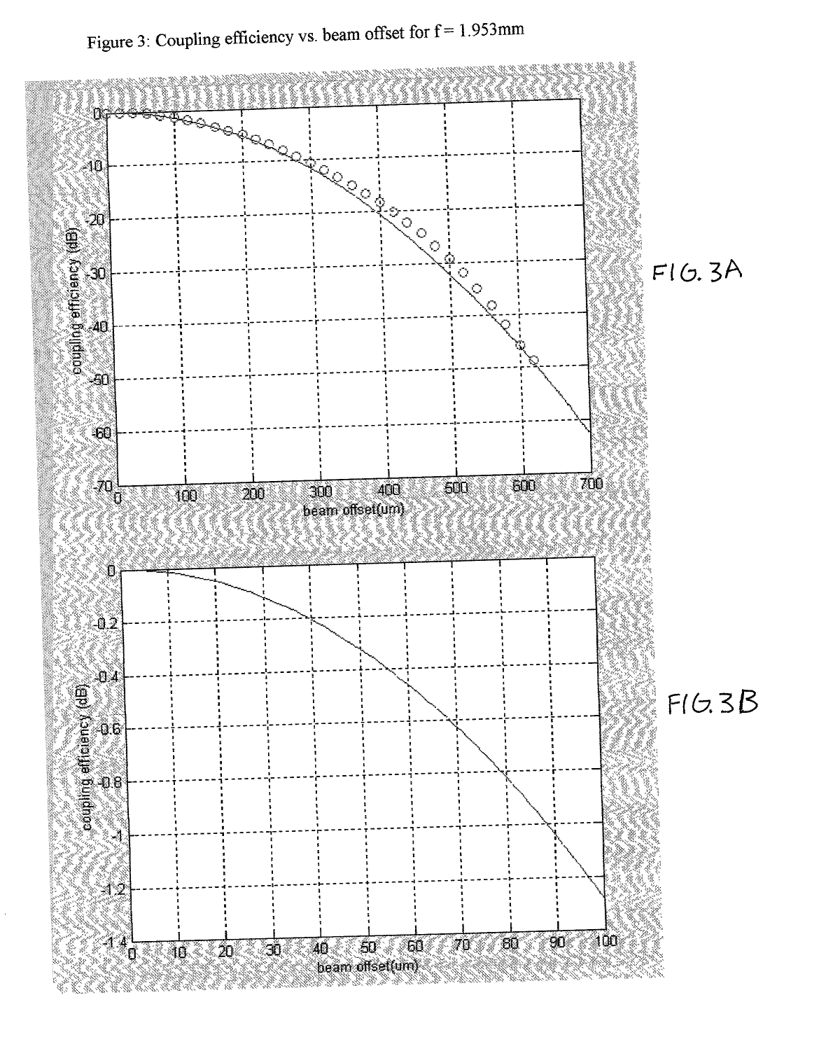

FIG. 2A shows the coupling efficiency as a function of cone angle mismatch. FIG. 2B shows the coupling efficiency in dB. In the first 11.5 degrees, the efficiency drops to −20 dB. To reduce the power down to −60 dB, the cone angle has to be offset by 20 degrees. For an effective focal length of 1.953 mm, 20 degrees angular offset on the focal plane corresponds to a 680 μm beam offset at the collimating space. FIG. 3A shows the coupling efficiency as a function of beam offset. The continuous curve is the result of theoretical modeling and the curve depicted by the circles is the experimental data. They agree to each other reasonabely well. FIG. 3B shows a magnified portion of FIG. 3A.

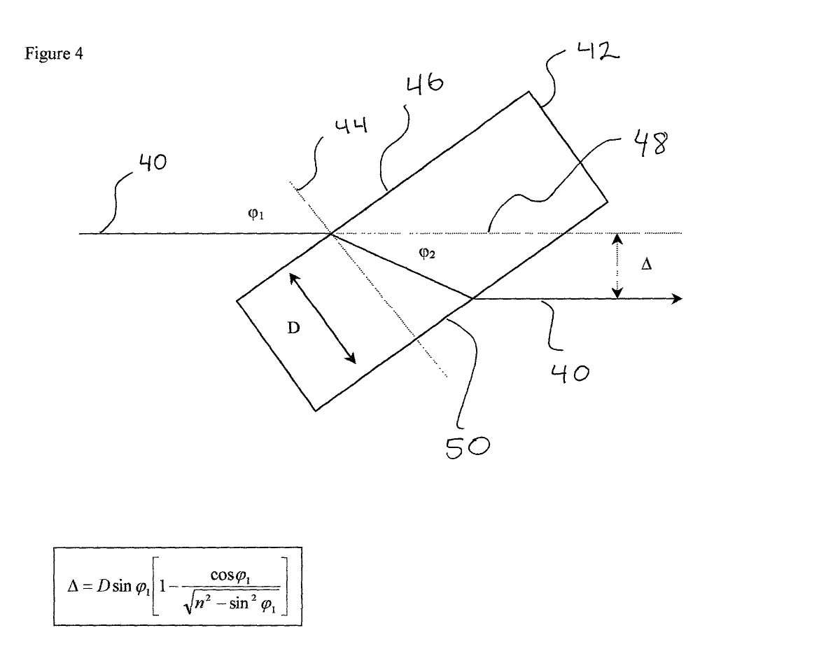

FIG. 4 shows the geometry of the beam offset and the incident angle. A beam 40 is incident upon the surface 46 of substrate 42 at an angle φ₁ relative to the normal 44 of surface 46. The beam 40 travels at an angle φ₂ away from the path 48 that beam 40 would have traveled if unperturbed. The beam 40 exits the substrate 42 at surface 50 at an offset Δ to the unperturbed beam path 48. The beam offset is therefore dependent upon the thickness D, the index of refraction of the substrate 42 and on the angle of incidence φ₁. The dependence satisfies Equation (2).

$$Δ = D sin {ϕ}_{1} [ 1 - \frac{cos {ϕ}_{1}}{\sqrt{{n}^{2} - {sin}^{2} {ϕ}_{1}}} ] \qquad Equation ( 2 )$$

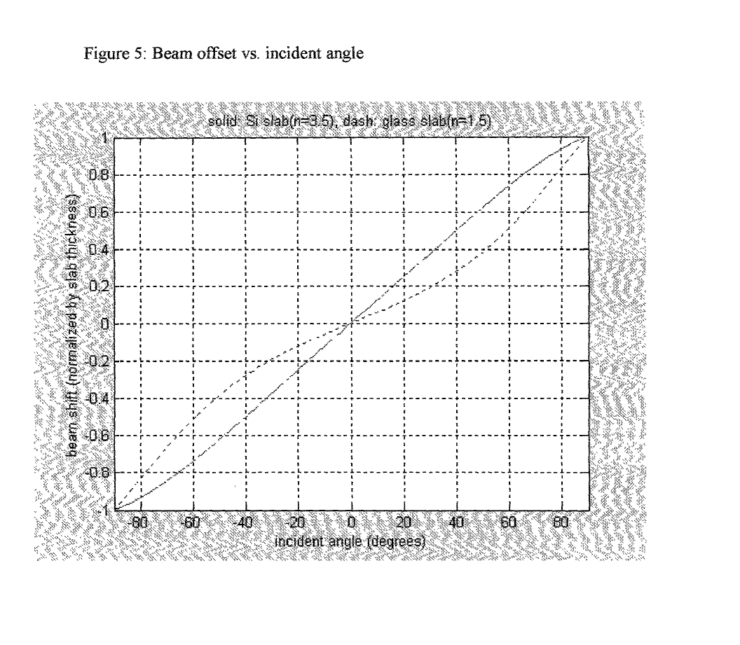

FIG. 5 shows the beam offset as a function of incident angle for silicon (n=3.5, solid curve) and glass (n=1.5, dashed curve). Notice the nearly linear dependence over all incident angles for silicon.

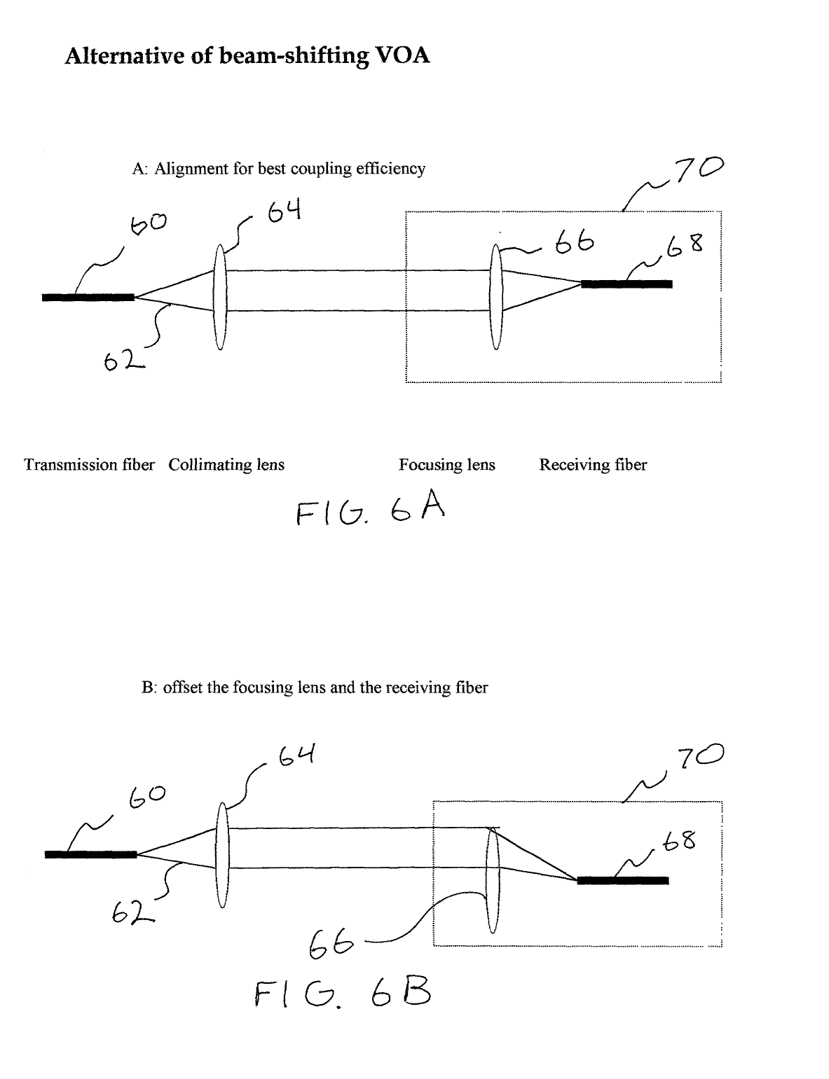

FIGS. 6A and 6B illustrate an alternate embodiment of the invention. FIG. 6A shows a transmission fiber 60 providing light 62, which is collimated by lens 64 and then refocused by lens 66 into receiving fiber 68. Focusing lens 66 and receiving fiber 68 may be attached to a single board 70. The alignment shown in FIG. 6A provides optimal coupling efficiency. As discussed above, the focusing optic 66 focuses light 62 into a cone and the receiving fiber optic has an input cone angle. FIG. 6B shows the focusing lens 66 and the receiving fiber 68 offset from the position of the beam transmitted from the collimating lens 64. Such alignment produces an offset between the output cone angle of the focusing optic and the input cone of the fiber optic 68. By selectively moving the focusing optic and the receiving fiber, a selected intensity can be input into the fiber optic.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

We claim:

1. A variable optical attenuator (VOA), comprising:
means for producing a focused beam having a focused cone angle;
an output optical transmission medium having an input cone angle; and
means for selectively altering the match between said focused cone angle and said input cone angle.

2. The VOA of claim 1, wherein said means for producing a focused beam comprises:
a collimating element for receiving a light beam originating from an input optical transmission medium; and
a focusing element opposing said collimating element and operative to substantially focus said light beam upon an output optical transmission medium.

3. The VOA of claim 1, wherein said means for selectively altering the match between said focused cone angle and said input cone angle comprises a rotatable optical member (ROM) disposed in between said collimating element and said focusing element and capable of rotating to selectively attenuate said light beam.

4. The VOA of claim 3, wherein said ROM selectively attenuates said light beam as a function of the angular position of said ROM relative to said light beam.

5. The VOA of claim 3, wherein said ROM laterally shifts said light beam.

6. The VOA of claim 3, wherein said focusing element substantially focuses said light beam in an output cone angle, wherein said output optical transmission medium comprises an output fiber optic having an input cone angle, wherein said ROM laterally shifts said light beam and produces a cone angle mismatch between said output cone angle and said input cone angle, wherein coupling efficiency into said output fiber optic is selectively reduced.

7. The VOA of claim 6, wherein the coupling efficiency of said light beam into said output fiber optic varies with the angle of incidence of said light beam onto said ROM.

8. The VOA of claim 3, wherein said ROM comprises silicon.

9. The VOA of claim 3, wherein said ROM comprises glass.

10. The VOA of claim 2,wherein said collimating element transmits said light beam as a collimated light beam.

11. The VOA of claim 2 wherein said collimating element and said focusing element are each selected from the group consisting of a double convex lens, a spherical lens, a plano-convex lens, an aspherical lens, a gradient index lens and a holographic element.

12. The VOA of claim 2, wherein each of said input optical transmission medium and said output optical transmission medium are each selected from the group consisting of an optical fiber and an optical waveguide.

13. The VOA of claim 2, wherein said means for selectively altering the match between said focused cone angle and said input cone angle comprises means for moving the relative position of said focusing element with respect to said collimating element.

14. A method for selectively attenuating a light beam, comprising:
producing a focused beam having a focused cone angle;
providing an output optical transmission medium having an input cone angle; and
altering the match between said focused cone angle and said input cone angle.

15. The method of claim 14, wherein the step of producing a focused beam comprises:
collimating a light beam originating from an input optical transmission medium; and
focusing said light beam upon an output optical transmission medium.

16. The method of claim 14, wherein the step of selectively altering the match between said focused cone angle and said input cone angle comprises providing and rotating a rotatable optical member (ROM) disposed in between said collimating element and said focusing element and capable of rotating to selectively attenuate said light beam.

17. The method of claim 16, wherein said ROM selectively attenuates said light beam as a function of the angular position of said ROM relative to said light beam.

18. The method of claim 16, wherein said ROM laterally shifts said light beam.

19. The method of claim 16, wherein said focusing element substantially focuses said light beam in an output cone angle, wherein said output optical transmission medium comprises an output fiber optic having an input cone angle, wherein said ROM laterally shifts said light beam and produces a cone angle mismatch between said output cone angle and said input cone angle, wherein coupling efficiency into said output fiber optic is selectively reduced.

20. The method of claim 19, wherein the coupling efficiency of said light beam into said output fiber optic varies with the angle of incidence of said light beam onto said ROM.

21. The method of claim 16, wherein said ROM comprises silicon.

22. The method of claim 17, wherein said ROM comprises glass.

23. The method of claim 16,wherein said collimating element transmits said light beam as a collimated light beam.

24. The method of claim 15, wherein said collimating element and said focusing element are each selected from the group consisting of a double convex lens, a spherical lens, a plano-convex lens, an aspherical lens, a gradient index lens and a holographic element.

25. The method of claim 15, wherein each of said input optical transmission medium and said output optical transmission medium are each one of an optical fiber and an optical waveguide.

26. The method of claim 14, wherein the step of selectively altering the match between said focused cone angle and said input cone angle comprises moving the relative position of the collimated light beam with respect to the means for focusing said light beam upon an output optical transmission medium.
